(19) United States
(12) Patent Application Publication
(10) Pub. No.: US 2006/0023796 A1
(43) Pub. Date: Feb. 2, 2006

(54) ASK communication device

(76) Inventors: Yo Yanagida, Shizuoka-ken (JP); Naoyuki Shiraishi, Shizuoka-ken (JP); Atsushi Kawamura, Shizuoka-ken (JP); Terumitsu Sugimoto, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/193,418

(22) Filed: Aug. 1, 2005

(30) Foreign Application Priority Data
Aug. 2, 2004 (JP) 2004-225686

(51) Int. Cl. H04L 25/00; H04L 27/00

(52) U.S. Cl. 375/257; 375/259

(57) ABSTRACT

A master station includes a main clock generator using a high precision oscillator such as a crystal oscillator or a ceramic oscillator, and generates a carrier signal used for ASK modulation of a transmission signal in response to the clock signal outputted from the main clock generator. A slave station uses sampling means to sample the carrier signal sent from the master station, and generates a carrier signal used for ASK modulation of a transmission signal based on the sampling data.

### BACKGROUND OF THE INVENTION

The present invention relates to an ASK (Amplitude Shift Keying) communication device that establishes data communication between a master station and at least one slave station by using an ASK modulation scheme.

As a method of data communication between a master station and a slave station connected with each other via a bus line, there is a known technique using an ASK modulation scheme (for example, see Japanese Patent Application Laid-Open No. 2002-152291).

FIG. 1 is a block diagram schematically showing a configuration of a common ASK communication device. As shown in FIG. 1, the ASK communication device is designed so that a master station 101 and a slave station 102 are connected with each other via a bus line 103 to achieve data communication therebetween using an ASK scheme. The master station 101 includes an oscillator 112 that generates a clock signal, a CPU 111 that implements integral control and generates a carrier signal (carrier wave) of a desired frequency in response to the clock signal fed from the oscillator 112, a transmitter 113 that generates modulated data by ASK-modulating the carrier signal based on transmission data and then outputs the modulated data to the bus line 103, and a receiver 114 that receives modulated data sent from the slave station 102 through a filter 115 and then ASK-demodulates the received modulated data.

In a similar manner, the slave station 102 includes an oscillator 122, a CPU 121, a transmitter 123, a receiver 124, and a filter 125.

When data is transmitted from the master station 101 to the slave station 102, a carrier signal is generated in response to a clock signal outputted from the oscillator 112 and is then ASK-modulated based on transmission data, which is followed by outputting of ASK-modulated data to the bus line 103.

The modulated data is then received and ASK-demodulated by the receiver 124 of the slave station 102, and consequently the transmission data from the master station 101 can be obtained.

Also, when data is transmitted from the slave station 102 to the master station 101, a similar process to the above is applied. That is, a carrier signal is generated in response to a clock signal outputted from the oscillator 122, and is then ASK-modulated based on transmission data, which is followed by outputting of ASK-modulated data to the bus line 103. The modulated data is received and ASK-demodulated by the receiver 114 of the master station 101, and consequently the transmission data from the slave station 102 can be obtained. In this manner, data communication between the master station 101 and the slave station 102 can be achieved.

### SUMMARY OF THE INVENTION

In the foregoing conventional ASK communication device, however, both of the master station 101 and % the slave station 102 include oscillators 112 and 122, respectively, which have expensive components such as a ceramic oscillator or a crystal oscillator, which disadvantageously leads to an increase in parts count and thus in costs.

FIG. 1 shows the case where the master station 101 is connected to one slave station 102, but in practical cases as shown in FIG. 2, a plurality of slave stations (three slave stations in the drawing) are usually provided. In these cases, each slave station 102 has to have the oscillator 112 which is expensive, thereby causing the problem of a remarkable increase in parts counts and costs.

As described above, since the conventional ASK communication device is configured so that the master station 101 and each of the slave stations 102 must have therein an expensive oscillator for generating a clock signal and carrier signal, which disadvantageously leads to an increase in parts count and thus in costs.

The present invention has been achieved to overcome these conventional problems, and the present invention provides an ASK communication device which can reduce parts count and thus costs.

According to a technical aspect of the present invention, there is provided an ASK communication device having a transmitter-receiver for establishing data communication using ASK with a master station via a bus line, and the transmitter-receiver comprises a receiver that receives modulated data sent via the bus line and ASK-demodulates the received modulated data, sampling means for sampling a waveform of a carrier signal of the modulated data, the sampling being made based on a sampling clock having a sampling frequency higher than twice a frequency of the carrier signal, a local oscillator that generates an oscillator signal used to generate the sampling clock; a memory that stores waveform data of the sampled carrier signal, and a transmitter that generates modulated data of a transmission signal and outputs the modulated data to the bus line in which the transmitter generates a reproduction carrier signal based on the oscillator signal corresponding to the waveform data of the sampled carrier signal stored in the memory and modulates the reproduction carrier signal based on the transmission signal.

### BRIEF DESCRIPTION OF THE DRAWINGS

FIG. 1 is a block diagram showing a configuration of a conventional ASK communication device;

FIG. 2 is an explanatory diagram showing a configuration in which a master station is connected to three slave stations;

FIG. 3 is a block diagram showing a configuration of an ASK communication device according to one embodiment of the present invention;

FIG. 4 is a flowchart showing a processing procedure of sending data from a master station to a slave station;

FIG. 5 is a flowchart showing a processing procedure of receiving data sent from the master station at the slave station and also in sending data from the slave station to the master station;

FIG. 6 is a flowchart showing a processing procedure of receiving data sent from the slave station at the master station;

FIG. 7 is a timing chart showing time series changes in each signal;

FIG. 8 is an explanatory diagram showing sampling points in sampling a carrier signal; and

FIG. 9 is a block diagram showing a configuration in the case where the present invention is applied to an on-vehicle ASK communication device using power superimposed multiple communication.

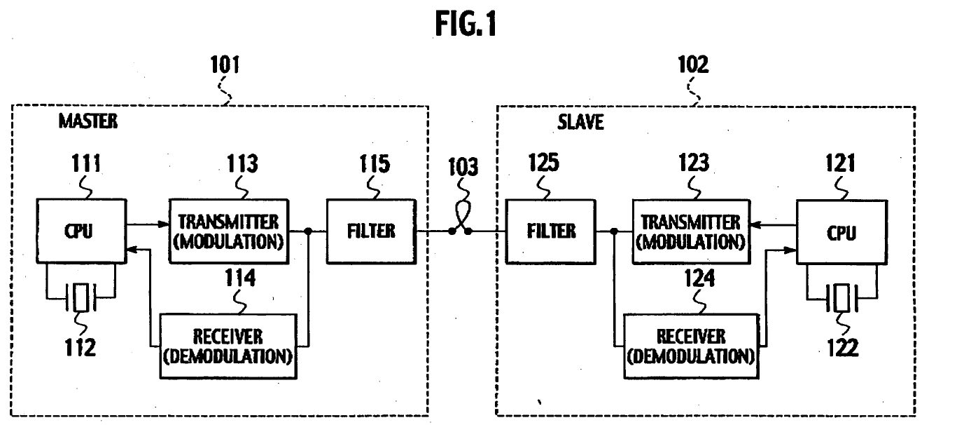

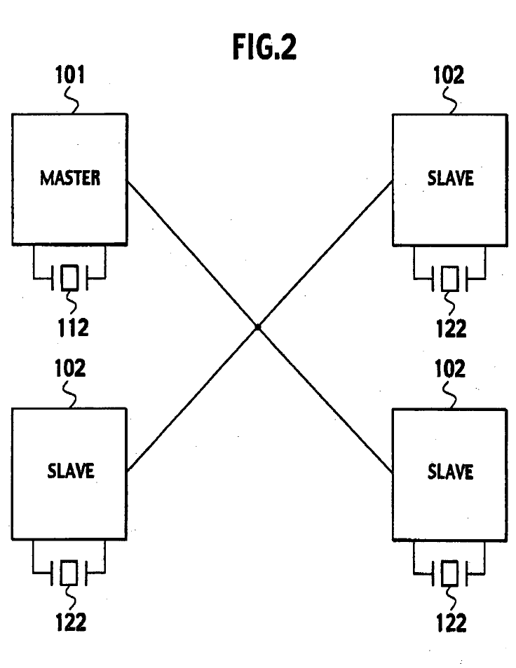

### DESCRIPTION OF THE PREFERRED EMBODIMENT

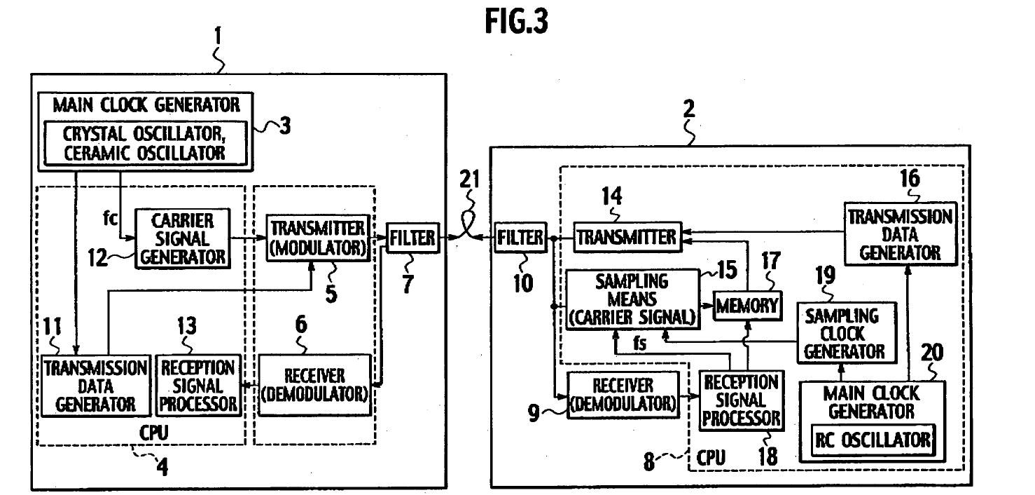

Preferred embodiments of the present invention will be explained below with reference to the accompanying drawings. FIG. 3 is a block diagram showing a configuration of an ASK communication device according to one embodiment of the present invention. As shown in FIG. 3, the ASK communication device comprises a master station (transmitter/receiver) 1, a slave station (transmitter/receiver) 2, and a bus line 21 for connecting the master station 1 and the slave station 2 with each other, and establishes data communication therebetween using an ASK modulation scheme. It should be noted here that there are plurality of slave stations 2 in general, only one slave station 2 is shown and described in this embodiment for simplicity.

The master station 1 includes a CPU 4, a main clock generator (oscillator circuit) 3 having a high precision oscillator, such as a crystal or ceramic oscillator, for generating a clock signal to drive the CPU 4, a transmitter (master side transmission means) 5, a receiver (master side receiving means) 6, and a filter 7.

The CPU 4 includes a carrier signal generator (carrier signal generation means) 12 that generates a carrier signal (carrier wave) having a desired frequency (for example, 2.5 MHz) for ASK communication in response to the clock signal output from the main clock generator 3, a transmission data generator 11 that generates transmission data to be sent from the master station 1 to the slave station 2, and a reception signal processor 13 that processes a base band signal received by the receiver 6.

The transmitter 5 ASK-modulates the carrier signal based on the transmission data outputted from the transmission data generator 11, and outputs the resultant modulated data to the bus line 21 through the filter 7.

The receiver 6 generates a baseband signal by ASK demodulation of modulated data that is sent from the slave station 2 via the bus line 21, and outputs the baseband signal to the reception signal processor 13.

The slave station 2 includes a CPU 8, a receiver (slave side receiving means) 9, and a filter 10. The receiver 9 receives modulated data sent from the master station 1 via the bus line 21, and generates a baseband signal by ASK demodulation of the received modulated data.

The CPU 8 includes a reception signal processor 18 that processes the baseband signal outputted from the receiver 9, a sampling unit (sampling means) 15 that samples the carrier signal fed from the master station 1 at a frequency fs (for example, 100 MHz) being higher than twice a frequency fc (for example, 2.5 MHz) of the carrier signal, and a memory (memory means) 17 that stores sampling data sampled by the sampling unit 15.

The CPU 8 further includes a main clock generator 20 having an RC circuit and the like for generating a main clock, a sampling clock generator 19 that generates a sampling clock for the sampling unit 15 in response to the clock signal outputted from the main clock generator 20, a transmission data generator 16 that generates transmission data to be sent from the slave station 2 to the master station 1, and a transmitter (slave side transmission means) 14 that generates a carrier signal based on the sampling data stored in the memory 17, ASK-modulates the generated carrier signal based on the transmission data outputted from the transmission data generator 16, and then outputs the modulated data to the bus line 21.

The main clock generator 20 is an RC oscillator and the like can be the one which ensures a low degree of clock accuracy, and is not an oscillator which outputs a clock signal with highly accurate and stable frequency, such as a crystal oscillator or ceramic oscillator provided in the main clock generator 3 of the master station 1.

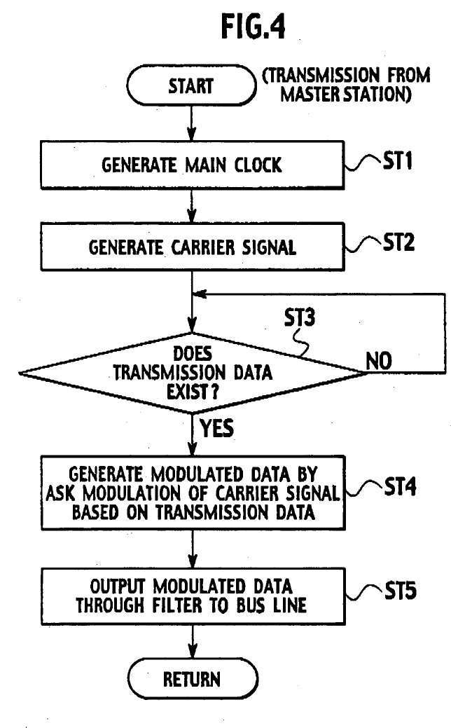

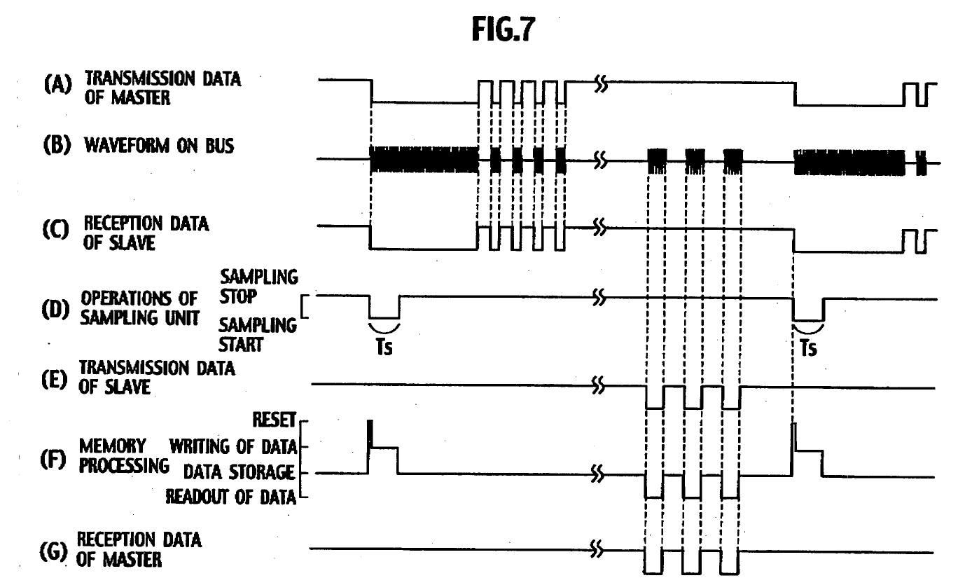

The operations of the ASK communication device thus configured according to this embodiment will be described below with reference to the flowcharts shown in FIGS. 4 to 6 and the timing chart shown in FIG. 7.

When data transmission is made from the master station 1 to the slave station 2, the main clock generator 3 of the master station 1 generates a main clock signal (step ST1 of FIG. 4). The carrier signal generator 12 generates a carrier signal of a desired frequency, for example, 2.5 MHz, in response to the main clock (step ST2).

When there is data to be sent (“YES” in step ST3), the transmission data generator 11 generates transmission data that varies at a frequency of, for example, 9.6 kHz, in response to the main clock provided by the main clock generator 3, and outputs the transmission data to the transmitter 5.

The transmitter 5 ASK-modulates the carrier signal given by the carrier signal generator 12 based on the transmission data provided by the transmission data generator 11 (step ST4), and then outputs resultant modulated data through the filter 7 to the bus line 21 (step ST5).

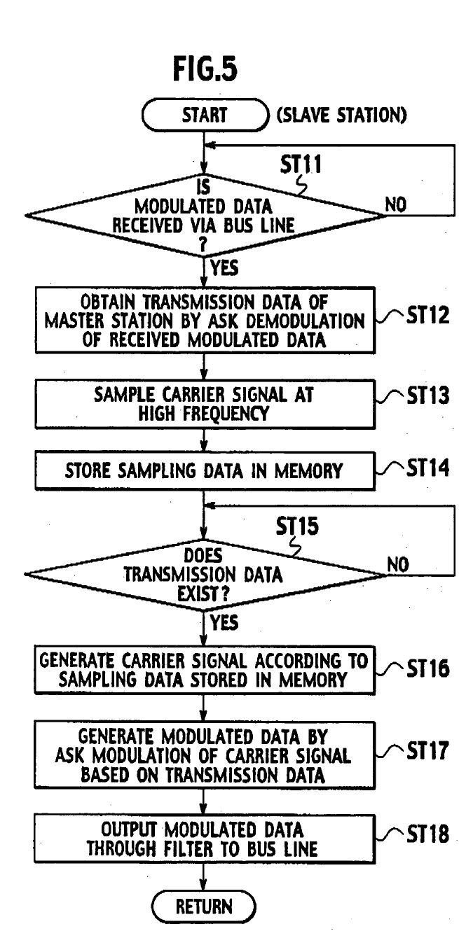

In the slave station 2, when the modulated data sent from the master station 1 via the bus line 21 is received by the receiver 9 (“YES” in step ST11 of FIG. 5), the receiver 9 ASK-demodulates the modulated data and obtains the transmission data sent from the master station 1 (step S12).

On the other hand, the sampling unit 15 samples a voltage waveform of the received carrier signal at a high frequency of, for example, 100 MHz, in response to the clock signal of the main clock generator 20 (step ST13), and then stores the sampling data in the memory 17 (step ST14).

Subsequently, when data transmission is made from the salve station 2 to the master station 1 (“YES” in step ST15), the transmission data generator 16 generates transmission data in response to the clock signal outputted from the main clock generator 20.

At this time, the transmitter 14 reads the sampling data stored in the memory 17, and generates a carrier signal based on the sampling data (step ST16). In addition, the transmitter 14 ASK-modulates the generated carrier signal based on the transmission data generated by the transmission data generator 16 thereby to generate modulated data (step ST17). The modulated data is then outputted through the filter 10 to the bus line 21 (step ST18).

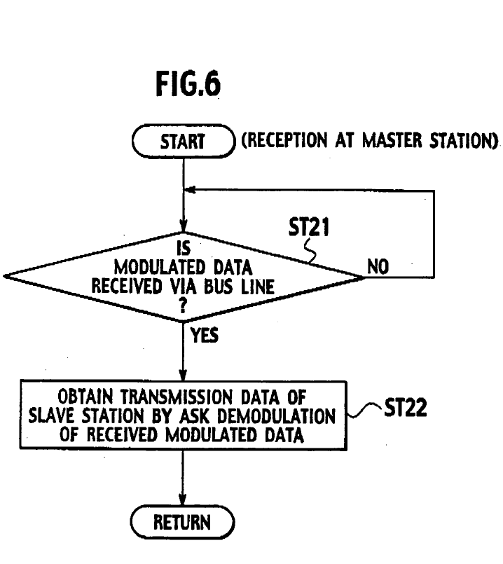

Subsequently in the master station 1, the receiver 6 receives the modulated data sent from the slave station 2 via the bus line 21 (“YES” in step ST21 of FIG. 6), and obtains the transmission data of the slave station 2 by ASK-demodulating the received modulated data (step ST22). In this manner, data communication is achieved between the master station 1 and the slave station 2.

A description will be given of time series changes in each signal with reference to the timing chart shown in FIG. 7. FIG. 7(a) shows transmission data prior to modulation which is generated in the master station 1, FIG. 7(b) shows a carrier signal ASK-modulated based on the transmission data, that is, modulated data output to the bus line 21, and FIG. 7(c) shows data obtained by demodulating the modulated data received by the slave station 2. FIG. 7(d) shows operation states of the sampling unit 15, FIG. 7(e) shows transmission data sent from the slave station 2 to the master station 1, FIG. 7(f) shows operations of the memory 17, and FIG. 7(g) shows data obtained by demodulating modulated data received by the master station 1.

When the transmission data as shown in FIG. 7(a) is generated by the transmission data generator 11 of FIG. 3 the transmitter 5 modulates a carrier signal based on the transmission data, so that the ASK-modulated carrier signal as shown in FIG. 7(b) is generated and is then outputted to the bus line 21.

Upon receipt of the modulated data shown in FIG. 7(b) the receiver 9 of the slave station 2 ASK-demodulates the modulated data thereby to obtain reception data shown in FIG. 7(c).

The sampling unit 15 samples, as shown in FIG. 7(d), the carrier signal used for carrying the modulated data of FIG. 7(b) for a time Ts from the receipt of the modulated data of FIG. 7(b) until one bit of the modulated data is completely given. The memory 7 is once reset at the start of sampling by the sampling unit 15, and then sampling data sampled by the sampling unit 15 is written to the memory 17, as shown in FIG. 7(f).

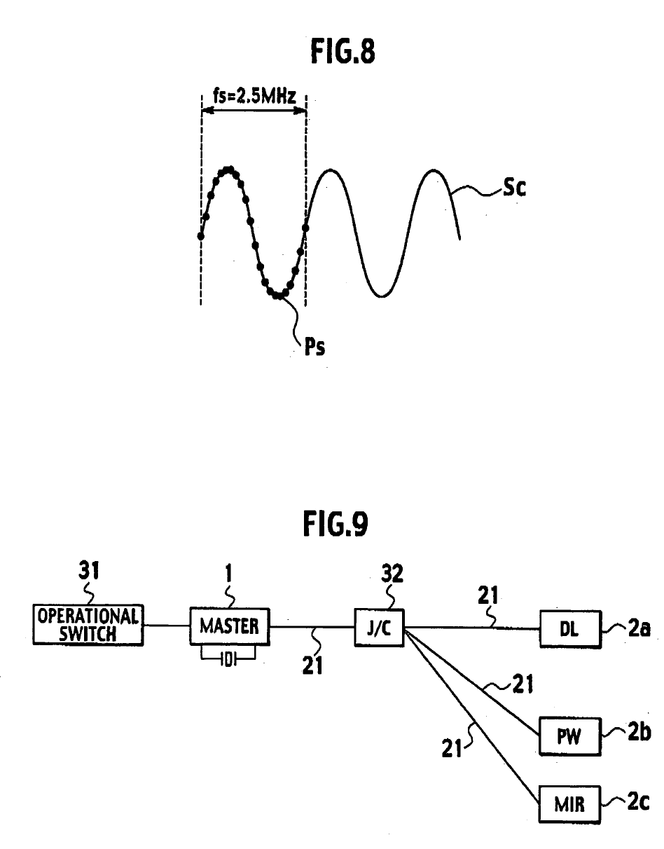

For example, when a carrier signal frequency fc is 2.5 MHz and a sampling frequency fs is 100 MHz, 40 sampling points Ps can be obtained within one period of a carrier signal Sc as shown in FIG. 8. At each sampling point, voltage values are determined, and waveform data of the carrier signal (aggregation of data at the sampling points Ps) is stored in the memory 17.

Subsequently, when data transmission is made from the slave station 2 to the master station 1, the transmitter 14 is provided with transmission data from the transmission data generator 16 with timing shown in FIG. 7(e), and then generates a carrier signal based on the sampling data that is read as waveform data stored in the memory 17 in synchronism with the output timing of the transmission data as shown in FIG. 7(f). That is, the transmitter 14 reproduces the clock signal (fc) generated in the main clock generator of the master station based on the clock signal of the slave station (fs≧2fc). The transmitter 14 subsequently ASK-modulates the generated carrier signal based on the transmission data, and outputs the modulated data to the bus line 21, so that the master station 1 can receive the data sent from the slave station 2 with timing shown in FIG. 7(g).

As described above, in the ASK communication device according to the present invention, the master station 1 uses a high precision oscillator circuit such as a crystal or ceramic oscillator in order to generate a clock signal, and also refers to waveform data of the clock signal in order to generate a carrier signal, which leads to the generation of stable frequency carrier signals.

On the other hand, the slave station 2 does not use the clock signal outputted from the main clock generator 20 but uses sampling data obtained by sampling the carrier signal sent from the master station 1, in order to generate a carrier signal. Furthermore, the carrier signal fc and the sampling clock fs of the slave station 2 each can be oscillations with independent frequencies and phases, and therefore the main clock generator 20 of the slave station 2 does not need a high precision and expensive oscillator such as a crystal or ceramic oscillator.

That is, the main clock generator 20 only have to generate a clock signal for driving components used for the purposes other than the generation of a carrier signal, and thus can use an inexpensive and simple oscillator such as an RC oscillator, which leads to a reduction in costs.

Although the use of an RC oscillator and the like for the main clock of the slave side results in low accuracy of clock as well as of sampling frequency (100 MHz) on the slave side, a larger number of sampling points enables accurate adjustment of the carrier signal generated on the slave side to the carrier frequency on the master side. Even when the carrier signal frequency is changed, there is no need to change the configuration associated with transmission from the slave side.

Furthermore, the RC oscillator can be integrated together with other components within an IC chip, which results in reduced parts count.

FIG. 9 is a block diagram showing a configuration in the case where the foregoing ASK communication device is applied to a power superimposed multiple communication system. As shown in FIG. 9, the master station 1 is connected to three slave stations 2a to 2c via the bus line 21 and a J/C (junction connector) 32. Of the three slave stations, the slave station 2a is a controller for door locks, the slave station 2b is a controller for power windows, and the slave station 2c is a controller for door mirrors. The bus line 21 is a power source line used for supplying power voltage to each station, and communication is established between these stations by superimposing communication data on the power source line.

The master station 1 is linked with an operational switch 31 to send operational signals inputted thereto to the slave stations 2a to 2c via the bus line 21, so as thereby to operate door locks, power windows, or door mirrors. Each of the slave stations 2a to 2c does not include any expensive oscillator circuit such as a crystal or ceramic oscillator, so that the size of circuitry and the cost thereof can be reduced.

While the ASK communication device has been described in the context of the preferred embodiment shown and discussed, it is to be understood that the present invention is not limited thereto, and each component is replaceable with any other components having the same function.

For example, the foregoing embodiment has described the case where the carrier signal frequency is 2.5 MHz and the sampling frequency in the sampling unit 15 is 100 MHz. The present invention is not, however, limited thereto, and the sampling frequency can be arbitrary values as long as it is higher than twice the carrier signal frequency.

### ADVANTAGES OF THE INVENTION

According to the present invention, the slave station does not need to have therein a high precision oscillator for generating a clock signal used for carrier signal generation, which can reduce the size of circuitry as well as costs.

Furthermore, the sampling means obtains sampling data by sampling the carrier signal sent from the master station during a time corresponding to 1-bit data, which enables efficient sampling processing.

Furthermore, as an oscillator circuit for generating a clock signal for driving components of the slave station, an inexpensive RC oscillator circuit having simple elements is used, thereby leading to a reduction in size of the device and thus in costs.

### INDUSTRIAL APPLICABILITY

The ASK communication device according to the present invention is remarkably useful to reduce the size of circuitry and costs.

This application claims benefit of priority under 35USC 5119 to Japanese Patent Applications No. 2004-225686, filed on Aug. 2, 2004, the entire contents of which are incorporated by reference herein. Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. An ASK communication device having a transmitter-receiver for establishing data communication using an ASK scheme with a master station via a bus line, the transmitter-receiver comprising:
a receiver that receives modulated data sent via the bus line and ASK-demodulates the received modulated data;
sampling means for sampling a waveform of a carrier signal of the modulated data, the sampling being made based on a sampling clock having a sampling frequency being higher than twice a frequency of the carrier signal;
a local oscillator generating an oscillator signal being used to generate the sampling clock;
a memory storing waveform data of the sampled carrier signal; and
a transmitter generating a reproduction carrier signal based on the oscillator signal corresponding to the waveform data of the sampled carrier signal stored in the memory, modulating the reproduction carrier signal based on the transmission signal, and outputting the modulated data to the bus line.

2. The ASK communication device according to claim 1, wherein the sampling means samples 1-bit length of the carrier signal being received via the bus line.

3. The ASK communication device according to claim 1, wherein the local oscillator has an RC oscillator circuit.

4. The ASK communication device according to claim 1, wherein
the master station comprises:
a carrier signal generator generating the carrier signal;
a transmitter that ASK-modulates the carrier signal and outputs the modulated data of a transmission signal to the bus line; and
an oscillator generating a clock signal by using a crystal oscillator or a ceramic oscillator, the clock signal being used to generate the carrier signal.
